(19) United States
(12) Patent Application Publication
(10) Pub. No.: US 2005/0063470 A1
(43) Pub. Date: Mar. 24, 2005

(54) Encoding method for the compression of a video sequence

(76) Inventors: Vincent Bottreau, Paris (FR); Marion Benetiere, Rueil Malmaison (FR)

Correspondence Address: Philips Electronics North America Corporation;Corporate Patent Counsel, PO Box 3001, Briarcliff Manor, NY, 10510, US

(21) Appl. No.: 10/498,756

(22) PCT Filed: Dec. 5, 2002
(86) PCT No.: PCT/IB02/05266

(30) Foreign Application Priority Data
Dec. 20, 2001 (EP) 01403318.7

(51) Int. Cl. H04N 7/12

(52) U.S. Cl. 375/240.19; 375/240.11; 375/240.18

(57) ABSTRACT

The invention relates to an encoding method for the compression of a video sequence by means of a three-dimensional wavelet transform. This method is based on a hierarchical subband encoding process leading to transform coefficients that constitute a hierarchical pyramid. A spatio-temporal orientation tree, in which the roots are formed with the pixels of the approximation subband and the offspring of each of these pixels is formed with the pixels of the higher subbands, defines the spatio-temporal relationship inside said pyramid. The initial subband structure of the wavelet transform is, in the encoding process, preserved by scanning the subbands one after the other in an order that respects the parent-off-spring dependencies formed in the tree, and flags “off/on ” are added to each coefficient of the tree in view of a progressive transmission of the most significant bits of the coefficients. According to the invention, an additional, specific one bit flag is added to each subband for giving an information about the overall state of its coefficients, said additional information about the parent-offspring dependencies of each subband being then used to either process said subband if said flag has a first one of its two possible values or skip it if said flag has the second one said two possible values.

The invention relates to an encoding method for the compression of a video sequence divided in groups of frames (GOFs) decomposed by means of a three-dimensional (3D) wavelet transform leading to a given number of successive resolution levels which correspond to the decomposition levels of said transform, said method being based on a hierarchical subband encoding process leading from the original set of picture elements (pixels) of each GOF to transform coefficients constituting a hierarchical pyramid, a spatio-temporal orientation tree—in which the roots are formed with the pixels of the approximation subband resulting from the 3D wavelet transform and the offspring of each of these pixels is formed with the pixels of the higher subbands corresponding to the image volume defined by these root pixels—defining the spatio-temporal relationship inside said hierarchical pyramid, the initial subband structure of the 3D wavelet transform being preserved by scanning the subbands one after the other in an order that respects the parent-offspring dependencies formed in said spatio-temporal tree, and specific one bit flags being added to each coefficient of the spatio-temporal tree in view of a progressive transmission of the most significant bits of the coefficients, these flags being such that at least one of them describes the state of a set of pixels and at least another one describes the state of a single pixel.

Video streaming over heterogeneous networks requires a high scalability capability, i.e. that means that parts of a bitstream can be decoded without a complete decoding of the sequence and can be combined to reconstruct the initial video information at lower spatial or temporal resolutions (spatial scalability, temporal scalability) or with lower quality (SNR or bitrate scalability). A convenient way to achieve all these three types of scalability (scalable, temporal, SNR) is a three-dimensional (3D, or 2D+t) wavelet decomposition of the input video sequence, after a motion compensation of said sequence. The document WO 01/84847 (PHFR000044) describes a fully scalable method of video coding according to which a temporal (resp. spatial) scalability is obtained by performing a motion estimation at each temporal resolution level (resp. at the highest spatial resolution level). Hierarchical encoding of the resulting spatio-temporal trees is performed by means of a new encoding module based on the technique named Fully Scalable Zerotree (FSZ). An overview of this fully scalable coding method can also be found in “A Fully Scalable 3D Subband Video Codec”, by V. Bottreau, M. Bénetière, B. Felts and B. Pesquet-Popescu, Proceedings of IEEE Signal Processing Society, 2001 International Conference on Image Processing, Thessaloniki, Greece, Oct. 7-10, 2001, pp. 1017-1020.

This previous technique is inspired of the so-called Set Partitioning In Hierarchical Trees algorithm (SPIHT), the principles of which must first be recalled. The original SPIHT algorithm, described for instance in “A new, fast, and efficient image codec based on set partitioning in hierarchical trees”, A. Said and W. A. Pearlman, IEEE Transactions on Circuits and Systems for Video Technology, vol. 6, n^{o} 3, June 1996, pp. 243-250, and, for its extension to the 3D case, for instance in “An embedded wavelet video coder using three-dimensional set partitioning in hierarchical trees (SPIHT)”, B. J. Kim and W. A. Pearlman, Proceedings of Data Compression Conference, Mar. 25-27, 1997, Snowbird, Utah, USA, pp. 251-260, is based on a key concept: a partial sorting of the coefficients according to a decreasing magnitude, and the prediction of the absence of significant information across scales of the wavelet decomposition by exploiting self-similarity inherent in natural images. This means that if a coefficient is insignificant at the lowest scale of the wavelet decomposition, the coefficients corresponding to the same area at the other scales have a high probability to be insignificant too. Basically, the SPIHT is an iterative algorithm that consists in comparing a set of pixels corresponding to the same image area at different resolutions with a value called “level of significance”, from the maximal significance level found in the spatio-temporal decomposition tree down to 0. For a given level, or bitplane, two passes are carried out: the sorting pass, which looks for zero-trees or sub-trees and sorts insignificant and significant coefficients, and the refinement pass, which sends the precision bits of the significant coefficients. The SPIHT algorithm examines the wavelet coefficients from the highest level of the decomposition to the lowest one. This corresponds to first considering the coefficients corresponding to important details located in the smallest scale subbands, with increasing resolution, and then examining the smallest coefficients, which correspond to finer details. This justifies the “hierarchical” designation of the algorithm: the bits are sent by decreasing importance of the details they represent, and a progressive bitstream is thus formed.

A tree structure, called spatial (or spatio-temporal in the 3D case) orientation tree, defines the spatial (or spatio-temporal) relationship inside the hierarchical pyramid of wavelet coefficients. The roots of the trees are formed with the pixels of the approximation subband at the lowest resolution (“root” subband), while the pixels of the higher subbands corresponding to the image area (to the image volume, in the 3D case) defined by the root pixel form the offspring of this pixel. In the 3D version of the SPIHT algorithm, each pixel of any subband but the leaves has 8 offspring pixels, and each pixel has only one parent (with one exception for this rule: in the root case, one pixel out of 8 has no offspring). The following notations describe the parent-offspring relationship:

O(x,y,z): set of coordinates of the direct offspring of the node (x,y,z)

D(x,y,z): set of coordinates of all descendants of the node (x,y,z);

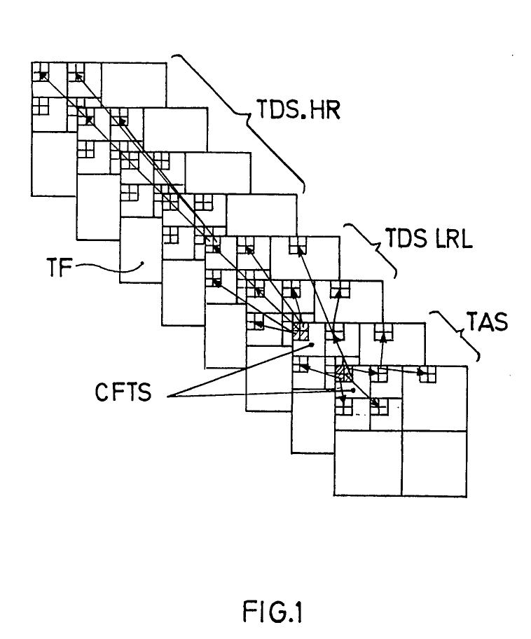

H(x,y,z): set of coordinates of all spatio-temporal orientation tree roots (nodes in the highest pyramid level: spatio-temporal approximation subband)
L(x,y,z)=D(x,y,z)−O(x,y,z)
(and an illustration of these dependencies is given in the three-dimensional case in FIG. 1, where the notations are the following: TF=temporal frame, TAS=temporal approximation subband, CFTS=coefficients in the spatio-temporal approximation subbands (or root coefficients), TDS.LRL=temporal detail subband at the last resolution level of the decomposition, and TDS.HR=temporal detail subband at higher resolution).

The SPIHT algorithm makes use of three lists : the LIS (list of insignificant sets), the LIP (list of insignificant pixels), and the LSP (list of significant pixels). In all these lists, each entry is identified by a set of coordinates (x,y,z). In the LIP and LIS, (x,y,z) represents a unique coefficient, while in the LIS it represents a set of coefficients D(x,y,z) or L(x,y,z), which are sub-trees of the spatio-temporal tree. To differentiate between them, the LIS entry is of type A if it represents D(x,y,z), and of type B if it represents L(x,y,z). During the first pass (sorting pass), all the pixels of the LIP are tested and those that become significant are moved to the list LSP. Similarly, the sets of the LIS that become significant are removed from the list LIS and split into subsets that are placed at the end of the LIS and will be each examined in turn. The LSP contains the list of significant pixels to be “refined” the n^{th} bit of the coefficient is sent if this one is significant with respect to the level n.

To improve the global compression rate of the video coding system, it is then usually advised to add an arithmetic encoder to the zero-tree encoding module. In other approaches, most of the time, the hierarchical and arithmetic coding modules are considered separately. To efficiently combine them in a single coding system, some modifications have to be performed on the original SPIHT algorithm. Although the use of lists LIS, LIP and LSP in SPIHT facilitates the classification task, these lists are an obstacle to a geographic organization of the coefficients. The in-depth search performed when scanning for zero-trees does not exploit the redundancy inside subbands and makes harder the determination of a relevant context for the arithmetic coding (the context is the information that may have some influence on the current pixel and particularly the information related to neighboring pixels). The manipulation of the lists LIS, LIP, LSP conducted by a set of logical conditions makes the order of pixel scanning hardly predictable. The pixels belonging to the same 3D offspring tree but coming from different spatio-temporal subbands are encoded and put one after the other in the lists, which has for effect to mix the pixels of foreign subbands. Thus, the geographic interdependencies between pixels of the same subband are lost. Moreover, since the spatio-temporal subbands result from temporal or spatial filtering, the frames of the sequence are filtered along privileged axes that give the orientation of the details. This orientation dependency is also lost when the SPIHT algorithm is applied, because the scanning does not respect the geographic order.

Furthermore, the bits resulting from the examination of the lists LIS, LIP, LSP and the signs of the coefficients have quite different statistical properties. The relevant contexts for one list can be totally different from another. For example, as the LIP represents the set of insignificant pixels, it is considered that if a pixel is surrounded by insignificant pixels, it has great chance to be insignificant too, but, for the LSP, it cannot be necessarily deduced that the refinement bit of an examined pixel is one (resp. zero) if the refinement bits of its neighbors are ones (resp. zeros) at a certain level of significance.

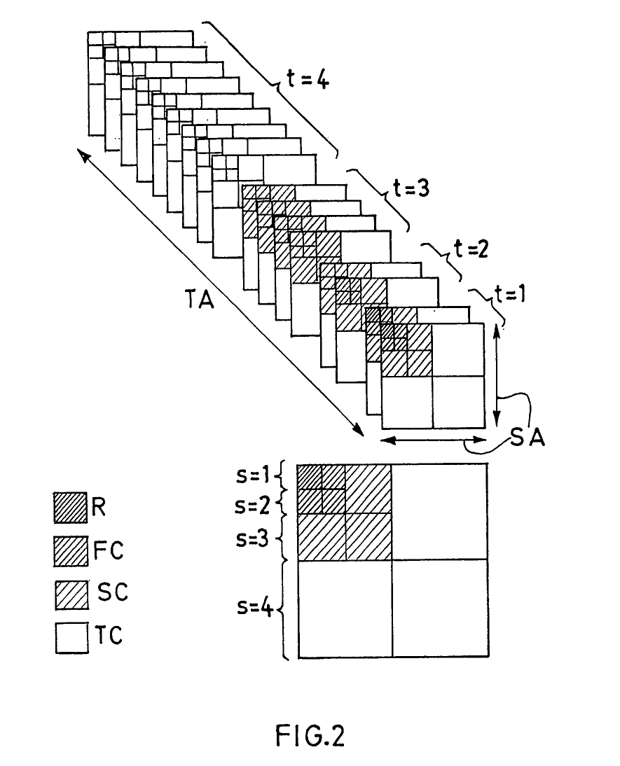

By using the technique described in the document WO 01/84847 already cited, the initial subband structure of the 3D wavelet transform can be preserved, and a marker, or flag, added to each coefficient indicates to which list LIS, LIP or LSP this coefficient belongs. More precisely, in the method considered in said patent application, the whole spatio-temporal tree is fully scanned for each new bitplane. At the end of the first bitplane, all the offspring dependencies of the 3D volume have been evaluated (this first scanning is therefore quite critical and must absolutely respect the calculation order of the offspring dependencies described in FIG. 2, where the notations are the following: SA=spatial axes (s), TA=temporal axis (t), R=roots, FC=first children, SC=second children, and TC=third children). According to said method, the subbands are scanned one after the other in an order that respects the parent-offspring relationships, and at least two different flags, and preferably four, are added to the coefficients of the spatio-temporal tree:
A) at least one, and preferably two of them describe the state of a set (trees or subtrees):
   DIRECT_SET_INSIG (or FS1) if D(x,y,z) is still insignificant;
   INDIRECT_SET_INSIG (or FS2) if L(x,y,z) is still insignificant.
B) at least another one, and preferably the two other ones describe the state of a single pixel:
   SIG (or FP3) if the current pixel is significant;
   INSIG (or FP4) if it is not significant, or if its significance is to be analyzed (put by default to the pixels that are not included in a zero-tree).
      The main steps of the method are:
1. Initialization:
   Put flag FP4 to all the coefficients of the lowest spatio-temporal subband;
   Put flag FS1 to 7 over 8 coefficients of the lowest spatio-temporal subband.
2. Calculate and output MSL (the maximum significance level found in the spatio-temporal decomposition tree).

3. From n=MSL down to 0, do a full exploration of the spatio-temporal tree (two main approaches are possible, as described in the following paragraph: spatially-driven resolution scalability, and temporally-driven resolution scalability), with, for each coefficient (x,y,z) of the spatio-temporal tree, the following actions

```
a) set significance :
    1) if flag FS1 is “on”, then output = Sₙ (D(x,y,z)).
if Sₙ (D(x,y,z)) = 1, then :
        - for each (x′,y′,z′) ∈ O(x,y,z), put flag FP4 ;
        - remove flag FS1 from (x,y,z) ;
            - if L(i,j) ≠Ø, then put flag FS2.
    2) if flag FS2 is “on”, then output = Sₙ (L(x,y,z)).
if Sₙ (L(x,y,z)) = 1, then :
        - for each (x′,y′,z′) ∈ O(x,y,z), put flag FS1 ;
            - remove flag FS2 from (x,y,z).
b) pixel significance :
    (1) if flag FP3 is on, then output = the n^{th} bit of (x,y,z).
2) if flag FP4 is on, then output = Sₙ (x,y,z).
    if Sₙ(x,y,z) = 1, then :
              put flag FP3 on ;
              output sign (x,y,z) ;
              remove flag FP4.
```

The frames are filtered along privileged axes (spatial or temporal) that give the orientations of the details. These orientations can be better taken into account by scanning the subband along the same directions. Using the indicated method, there are then two main ways of exploring the spatio-temporal volume of coefficients depending on the chosen privileged orientation, which may be either the spatial or the temporal axis. Consequently, two types of “multi-scalable” bitstreams may be obtained, a first one lead by the spatial resolution, and a second one lead by the temporal resolution:
(A) Spatially-Driven Resolution Scalability:

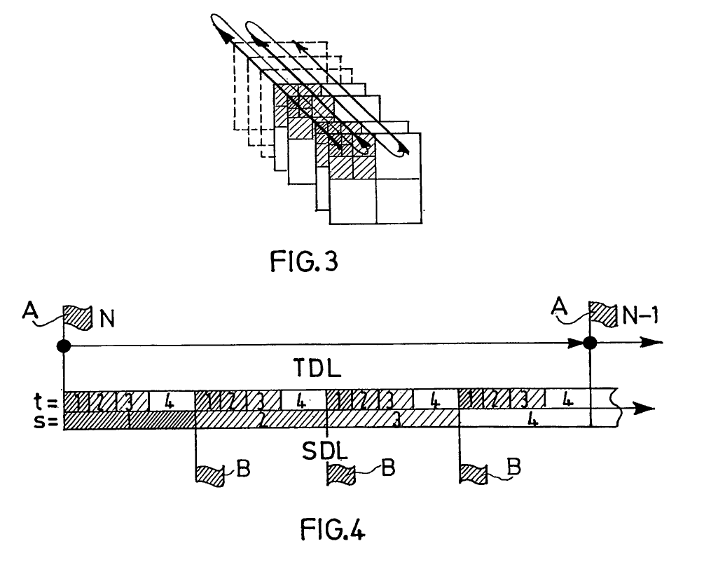

For each bitplane, the tree scanning is spatially oriented, since in this scheme the spatial resolutions are fully explored one after the other as shown in FIG. 3, all the temporal resolutions being successively scanned inside each spatial scale. In other words, the temporal frequency is higher than the spatial one. In order to have the possibility to skip some part of the bitstream, resolution flags are introduced in the bitstream. The scanning strategy leads to a video bitstream organized as indicated in FIG. 4, where the lines s and t correspond respectively to spatial and temporal decomposition levels (SDL and TDL), the flags A are flags separating two bitplanes, and the flags B are flags separating two spatial decomposition levels.

(B) Temporally-Driven Resolution Scalability:

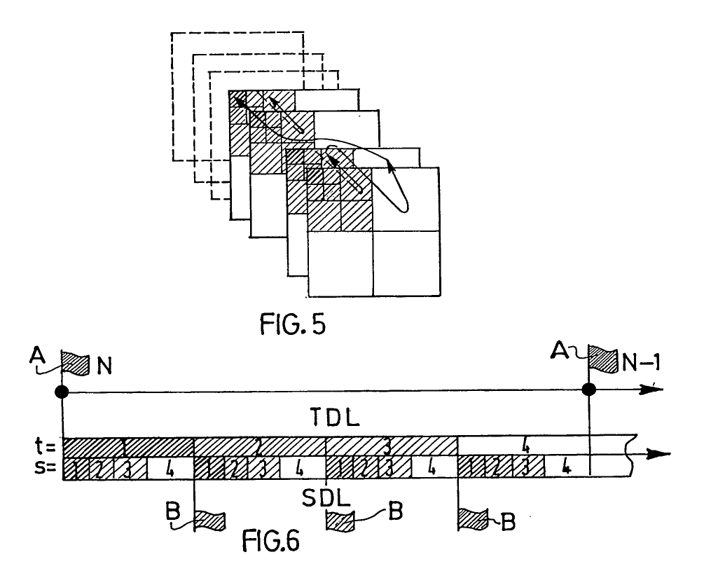

For each bitplane, the tree scanning is temporally oriented, since in this scheme the temporal resolutions are fully explored one after the other as shown in FIG. 5, all the spatial resolutions being successively scanned inside each temporal scale. This scanning strategy leads to a video bitstream organized as indicated in FIG. 6, to be compared with FIG. 4 (the flags B now separate two temporal decomposition levels). In both cases, the three types of scalability (temporal, spatial resolution, SNR) are obtained: the SNR scalability is still available since the spatio-temporal scanning is inserted in a bitplane iterative loop, and the temporal and spatial scalability are provided respectively with tₘₐₓ possible frame rates and sₘₐₓ possible display sizes (t=1 to 4 and s=1 to 4 in the described examples), with t=1 corresponding to the minimum frame rateₘᵢₙ, and s=1 corresponding to the minimum display size.

With this method, thanks to the fixed subband scanning (replacing the scanning of the lists) and the recognition of the flags, a coherent geographic context is restituted for each model: the initial subband structure of the 3D wavelet transform is preserved, and the flag added to each coefficient indicates to which list LIS, LIP or LSP this coefficient belongs. The hierarchical and logical organization of the SPIHT is preserved, and in the same time moving a coefficient from a list to another is “virtually” done by changing its flag, the order of reading being now not dependent of the changes performed by the logic of the SPIHT algorithm. This method, which better exploits the neighboring influence on the current pixel than those which combine classical SPIHT algorithm and entropy coding (and leads to a “natural” context directly issued from the transformed image, in conformity with the bitplane approach, and not from the bits resulting from the original SPIHT algorithm in the refinement passes), improves the compression rate and therefore the coding efficiency, as the context is really related to the bit being encoded.

However, the exhaustive scanning of all the spatio-temporal tree subbands rapidly leads to the following drawback: even at low decoding bitrate, a high computation load is observed, which is contradictory with the requirements of nowadays video applications.

It is therefore an object of the invention to propose an encoding method avoiding this drawback.

To this end, the invention relates to an encoding method such as defined in the introductory part of the description and which is moreover characterized in that an additional, specific one bit flag is added to each subband of the spatio-temporal tree for giving an information about the overall state of its coefficients, said additional information about the parent-offspring dependencies of each subband being then used for the following decision:
each subband has to be processed when its additional flag has the first of its two possible values, called “on”, at least one of its coefficients having a coefficient flag “on”;
each subband has to be skipped when its additional flag has the second one of the two possible values, called “off”, all its coefficients flags being “off”.

The technical solution thus proposed allows for each spatiotemporal subband to add, prior to any calculation, an information (such as a marker, or flag) concerning its parent-offspring dependencies, in such a way that if a particular subband is found to be not related to any other subband according to this flag, its encoding\decoding process is skipped, thus avoiding heavy and useless computations. It should be noted that the proposed invention does not result in any modification of the FSZ output bitstream and therefore does not lead to any quality degradation of the later reconstructed video.

The present invention will now be described with reference to the accompanying drawings in which:

FIG. 1 gives examples of parent-offspring dependencies in the 3D case, in the spatio-temporal orientation tree;

FIG. 2 illustrates the hierarchy of the subbands in said spatio-temporal tree;

FIG. 3 shows a spatially-driven scanning of the spatio-temporal tree;

FIG. 4 depicts a bitstream organization made possible by the ordered 3D SPIHT;

FIG. 5 shows a temporally-driven scanning of the spatio-temporal tree, and

FIG. 6 depicts the structure of the bitstream obtained with said scanning.

As seen above, in the FSZ technique, the whole spatio-temporal tree resulting from the wavelet decomposition is fully scanned bitplane (or significance level) by bitplane, all the parent-offspring dependencies (illustrated in FIG. 1) being established during the first bitplane processing. This hierarchical relationship determines the subband scanning order that is followed for all the remaining bitplanes (both at encoder and decoder side, no distinction being therefore made between encoder and decoder in the following since they both strictly respect the same order). As explained in the document WO 01/84847 above-mentioned, the main steps of the FSZ algorithm are the following:

(A) the initialization step, during which only the lowest spatio-temporal subband coefficients are characterized by flags enabling the beginning of the scanning process, all the other subband coefficients being initialized to zero;

(B) the scanning step, during which a full exploration of the spatio-temporal tree is performed for each bitplane in an order that strictly respects the parent-offspring dependencies formed in said spatio-temporal tree.

During this in-depth scanning, the state of the spatio-temporal subband coefficients is virtually changed by turning ON or OFF their description flags. The scanning of the spatio-temporal tree is fully exhaustive: every subband is reviewed, without any a priori assumption about the state of its coefficients, which means that for each subband, every coefficient is analyzed. However, when examining said FSZ technique in details, one may remark that in the particular case when none of the four possible flags (FS1=DIREC_SET_INSIG for insignificant set of direct offspring, FS2=INDIRECT_SET_INSIG for insignificant set of indirect offspring, FP3=SIG for significant pixel, FP4=INSIG for insignificant pixel) is ON (equivalent to zero), not only none information is output in the bitstream, but also none coefficient state is changed. In other words, the processing of such a coefficient is useless since it does not bring any additional information. This computational load overhead is particularly important when a subband contains only such coefficients. Moreover, this situation is very frequent for the first bitplanes since every subband, except the lowest one, is initialized to zero.

According to the present invention, it is therefore proposed to add to each subband a flag SCAN that gives an indication of the overall state of its coefficients. When ON (that is to say at least one coefficient of the subband has a flag different from zero), this flag allows the processing of the subband. When OFF (that is to say all the coefficient flags are equal to zero), the subband is skipped, since it is known that neither any bit will be output nor any flag will be changed. Considering the two main steps of the original FSZ method, it is proposed, according to the invention, to initialize the SCAN flag to ON for the lowest spatio-temporal subband (this root subband must be scanned in any case) and to OFF for all the other subbands. Starting from the root subband coefficients, the method will then update the flags of the offspring according to the rules defined in FSZ. The SCAN flag of the subbands that contain these offspring coefficients are then set to ON since they will have to be analyzed during a further sorting pass (for lower bitplanes).

In short, the present invention proposes to modify the FSZ method (as originally described in the above-mentioned document) in the following steps, the added parts being written in italics)

```
1. Initialization:
    - Put flag FP4 to all the coefficients of the lowest spatiotemporal subband ;
    - Put flag FS1 to 7 over 8 coefficients of the lowest spatiotemporal subband ;
    - Put flag SCAN to ON to the lowest spatio-temporal subband ;
    - Put flag SCAN to OFF to all the other spatio-temporal subbands.
2. Calculate and output MSL.
3. From n = MSL down to 0, do a full exploration of the spatio-temporal tree, with, for each
subband :
A) if flag SCAN is OFF, skip the subband and go directly to the next subband in the spatio-
temporal tree ;
B) if flag SCAN is ON, then for each coefficient (x,y,z) of the spatio-temporal tree, the
following actions are provided :
    a) set significance:
        1) if flag FS1 is ON, then output = Sₙ(D(x,y,z)).
    if Sₙ(D(x,y,z)) == 1, then :
            - for each (x′,y′,z′) ∈ O(x,y,z) , put flag FP4 ;
            - remove flag FS1 from (x,y,z) ;
                - if L(i,j) ≠ 0, then put flag FS2 ;
-put flag SCAN-ON for each subband that contains each (x′,y′,z′) ∈ O(x,y,z) respectively.
        2) if flag FS2 is ON, then output = Sₙ (L(x,y,z)).
    if Sₙ (L(x,y,z))==1, then :
            - for each (x′,y′,z′) ∈ O(x,y,z) , put flag FS1 ;
            - remove flag FS2 from (x,y,z) ;
- put flag SCAN ON for each subband that contains each (x′,y′,z′) ∈ O(x,y,z) respectively.
    - b) pixel significance :
        1) if flag FP3 is ON, then output = the nth bit of (x,y,z).
        2) if flag FP4 is ON, then output = Sₙ(x,y,z).
    if Sₙ (x,y,z) == 1, then :
                put flag FP3 ON ;
                output sign (x,y,z) ;
                remove flag FP4.
```

The advantage of the implementation of the method according to the invention is a very noticeable complexity reduction of the FSZ method, without any modification of the final output bitstream. The complexity reduction is all the more important given that encoding/decoding bitrate is low, where only the most important bitplanes are processed and many subbands have not been yet connected to others by any parent-offspring dependencies, that is to say that many subbands still have their flag SCAN set to OFF and are therefore not analyzed, contrary to what was done in the original FSZ algorithm.

1. An encoding method for the compression of a video sequence divided in groups of frames (GOFs) decomposed by means of a three-dimensional (3D) wavelet transform leading to a given number of successive resolution levels which correspond to the decomposition levels of said transform, said method being based on a hierarchical subband encoding process leading from the original set of picture elements (pixels) of each GOF to transform coefficients constituting a hierarchical pyramid, a spatio-temporal orientation tree—in which the roots are formed with the pixels of the approximation subband resulting from the 3D wavelet transform and the offspring of each of these pixels is formed with the pixels of the higher subbands corresponding to the image volume defined by these root pixels—defining the spatio-temporal relationship inside said hierarchical pyramid, the initial subband structure of the 3D wavelet transform being preserved by scanning the subbands one after the other in an order that respects the parent-offspring dependencies formed in said spatio-temporal tree, and specific one bit flags being added to each coefficient of the spatio-temporal tree in view of a progressive transmission of the most significant bits of the coefficients, these flags being such that at least one of them describes the state of a set of pixels and at least another one describes the state of a single pixel, said encoding method being further characterized in that an additional, specific one bit flag is added to each subband of the spatio-temporal tree for giving an information about the overall state of its coefficients, said additional information about the parent-offspring dependencies of each subband being then used for the following decision:
each subband has to be processed when its additional flag has the first of its two possible values, called “on”, at least one of its coefficients having a coefficient flag “on”;
each subband has to be skipped when its additional flag has the second one of the two possible values, called “off”, all its coefficients flags being “off”.

2. An encoding method according to claim 1, in which two flags describe the state of a set of pixels and are, for each coefficient (x,y,z) of said spatio-temporal tree, FS1 if D(x,y,z) is still insignificant and FS2 if L(x,y,z) is still insignificant
where D(x,y,z) is the set of coordinates of all the descendants of the node (x,y,z) and L(x,y,z)=D(x,y,z)=O(x,y,z), with O(x,y,z) being the set of coordinates of the direct offspring of the node (x,y,z) and
two flags describe the state of a single pixel and are FP3 if the current pixel is significant and FP4 if it is not significant or if its significance is to be analyzed, said encoding method being further characterized in that, after an initialization step where the flag FP4 is put to all the coefficients of the lowest spatio-temporal subband, the flag FS1 is put to 7 over 8 coefficients of said lowest spatio-temporal subband, the additional flag is put to the first one (“on”) of its two values for the lowest spatio-temporal subband and to the second one (“off”) for all the other subbands, and the maximum significance level MSL is calculated, the exploration of the spatio-temporal tree, implemented according to said scanning order, includes the following steps:
From the bitplane n=MSL down to 0, do a full exploration of the spatiotemporal tree, where, for each subband:
A) if said additional flag has the second one of its values, skip the subband and go directly to the next subband in the spatiotemporal tree;
B) if said additional flag has the first one of its values, for each coefficient (x,y,z) of the spatio-temporal tree, the following actions are provided:
```
    a) set significance:
        1) if flag FS1 is ON, then output = Sₙ (D(x,y,z)).
    if Sₙ (D(x,y,z)) == 1, then:
            - for each (x′,y′,z′) ∈ O(x,y,z) , put flag FP4;
            - remove flag FS1 from (x,y,z) ;
                - if L(i,j) ≠ 0, then put flag FS2;
- put said additional flag to the first one of its values for each subband that contains each
(x′,y′,z′) ∈ O(x,y,z) respectively.
        2) if flag FS2 is ON, then output = Sₙ (L(x,y,z)).
    if Sₙ (L(x,y,z)) ==1, then:
            - for each (x′,y′,z′) ∈ O(x,y,z) , put flag FS1 ;
            - remove flag FS2 from (x,y,z) ;
-put said additional flag to the first one of its values for each subband that contains each
(x′,y′,z′) ∈ O(x,y,z) respectively.
    b) pixel significance:
        1) if flag FP3 is ON, then output = the nth bit of (x,y,z).
        2) if flag FP4 is ON, then output = Sₙ(x,y,z).
    if Sₙ (x,y,z) == 1, then:
            - put flag FP3 ON;
            - output sign (x,y,z) ;
            - remove flag FP4.
```
